(19) United States
(12) Patent Application Publication
(10) Pub. No.: US 2022/0075884 A1
(43) Pub. Date: Mar. 10, 2022

(54) COMPUTER SECURITY SYSTEM AND METHOD

(71) Applicant: Crisp Thinking Group Limited, England (GB)

(72) Inventors: Adam Hildreth, England (GB); James Geary, England (GB); Peter Maude, England (GB)

(21) Appl. No.: 17/464,267

(22) Filed: Sep. 1, 2021

(30) Foreign Application Priority Data
Sep. 2, 2020 (GB) 2013783.2

(51) Int. Cl. G06F 21/62; G08B 13/22

(52) U.S. Cl. CPC G06F 21/62; G08B 13/22

(57) ABSTRACT

Examples provide a computer security system comprising one or more sensors operably couplable to a remote computing device, wherein the one or more sensors are operable to detect a physical security breach of a location where the remote computing device is located, wherein, in response to detection of the physical security breach by the one or more security sensors, the remote computing device is operable to obfuscate one or more activities running on the remote computing device.

### BACKGROUND

Use of remote working environments is becoming increasingly prevalent in the modern world. Use of ‘home office’ spaces is increasing, while use of formal office space is decreasing significantly.

Remote working typically involves accessing all the same systems and data as a person would in an office environment. However, contrary to an office environment, there is a significantly increased likelihood of ‘unauthorised’ people, such as family members or visitors inadvertently viewing sensitive data, if they walk past an unattended computing device. For example, a spouse, partner or child could accidentally walk in on an analyst working for an authorised agency on finding illegal content, or a cleaner walking past an unattended device with sensitive data on the screen that was accidentally left open. In such situations, it is difficult to maintain a safe working environment which protects data from ‘unauthorised’ users, including viewing content and data for which they are not authorised or trained to deal with.

### BRIEF DESCRIPTION OF THE DRAWINGS

Further details, aspects, examples and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 shows an example of a remote home working environment according to an embodiment of the present disclosure;

FIG. 2 shows a high level schematic diagram of a security system according to an embodiment of the present disclosure;

FIG. 3 shows a schematic diagram of how embodiments of the present disclosure may be implemented in different layers of a remote computing device;

FIG. 4 shows a circuit diagram of a security monitoring module implemented using Bluetooth Low Energy according to an embodiment of the present disclosure;

FIG. 5 shows a full implementation of the security monitoring module of FIG. 4;

FIG. 6 shows example pseudo code for use with the security monitoring module of FIG. 4;

FIG. 7 shows a circuit diagram of a compliance monitoring module implemented using 433 Mhz RF technology, according to an embodiment of the present disclosure;

FIG. 8 shows a circuit diagram of a receiver module for use with the RF based compliance monitoring module of FIG. 7, according to an embodiment of the present disclosure;

FIG. 9 shows example pseudo code for use with the RF based compliance monitoring modules of FIGS. 7 and 8, according to an embodiment of the present disclosure;

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that example, but not necessarily in other examples.

According to the present disclosure, the term ‘computing device’ covers any electronic device that is capable of taking inputs, processing the inputs and then calculating results from the inputs. They are devices that typically have at least one processor and memory to store data, the data including base data for operation upon, and instructions that are executed by the at least one processor to carry out the actions of one or more programs, in order to carry out work, in the described remote working environments. Examples of such devices include, but are not limited to: desktop computers, laptops, tablet computers, smartphones, dedicated access terminals and the like. In the following, where such a computing device is operating at a location distinct from a, or it's, usual working placement (i.e. in the described remote working environment), then it may be referred to as a remote computing device.

According to the present disclosure, the term ‘remote computing device’ is any computing device that is currently operating remotely from a known secure environment such as an office, or any other designated place of work that is known to be a nominally generally physically secure place. This is to say, it is a device that is operating (or, at least, may be used at some points in time for work) that is outside of the physical security afforded by a computing device being located in the typical working environment that is a known secure location where any and all activities related to the work being carried out may be carried out without undue concern for any form of data security breach. As such, a remote computing device may be considered to be a computing device for which there is at least one readily identifiable potential security (or safety) risk of access by an unauthorised third party.

Safety vs security—a quick discussion of two related aspects of proper data protection(s) that may be applied to, and provided by, the present disclosure. Conceptually, data may have both a ‘security’ aspect, and(/or) a ‘safety’ aspect. The security aspect is the more typically thought about issue of prevention of unauthorised third parties gaining access to data to which they are not allowed—that is, such data needs to be kept secure from third party access, e.g. to prevent secrets being shared, or to protect particular data that may be commercially or legally privileged from being released, copied and the like (e.g. personally identifying information (PII), passwords, banking details, etc). Whereas, the safety aspect relates to the fact that being in possession of such data may be illegal, damaging, or otherwise detrimental to the third party if they access the data. Such safety aspects are particularly relevant when the data is readily viewable, and the result of merely looking at the data in passing could itself be damaging to the third party. A clear example of the safety aspect, in terms of the present disclosure, is if a child of a forum moderator were to see the raw material for which the moderator is employed to view and assess in order for a moderation decision to be made as to whether that data should be allowed onto, or maintained on, an online platform. Such raw material may be merely offensive (e.g. use verbally offensive language) at one end of the scale, but may be extremely damaging at the other end (e.g. mental damage in accidentally viewing extreme, illegal, immoral or otherwise unsavoury or unpleasant imagery, for example of a sexual nature, violence, religious hatred, and the like).

The present disclosure provides protection for both aspects of data access, and therefore, in the following detailed description, we will generally make use of the terms ‘secure’ (or ‘security’, and the like) to reference the apparatuses used, or the methodologies followed, but these terms may be used interchangeably with the terms ‘safe’ (or ‘safety’, etc) also. Accordingly, embodiments of the present disclosure may be used to protect the relevant data from being accessed, in particular viewed, by third parties, to prevent those unauthorised third parties from gaining information they should not be in possession of, but also to protect those third parties from the information itself in the case that accessing such data, especially in visual form, may, of itself, be harmful to said third parties.

In light of this second ‘safety’ aspect, the user of the disclosed system may be assumed to be ‘on side’ (i.e. proactively engaging and wanting to comply) with the administration of any form of protection that provides safety for the user's family members, or visitors, and the like. This may be in contrast to the mere ‘security’ aspect, where a user may be either uninterested in (e.g. lazy), or actively against (e.g. liable to misuse the information they have access to themselves), such measures. Put another way, it will likely be in the interest of the user of an apparatus, system, and/or methods of the present disclosure, to engage with and not try to circumvent the protections afforded by examples of the present disclosure.

Examples of the present disclosure may be applied to data from a ‘computer network’. According to the present disclosure, the term computer network is a set of computing devices connected together for the purpose of sharing resources, such as, but not limited to, data storage and data processing. Examples include the internet, work or home provided networks (e.g. Wireless Local Area Networks, Virtual Private Networks (VPNs) and the like). The computing devices of the computer network may include servers, workstations, routers, switches, etc. (i.e. network components), but also the other end user computing devices, as noted above, which are used to consumed and/or generate data, or the like. The network component examples of the computing devices used in a computer network may also be referenced as a communications device, particularly where providing the communications used in the computer network is their primary function, for example a router or switch. The term ‘computer network’ as used herein refers to one or more computing devices, communications devices and/or data storage devices connected in such a way as to be accessible remotely, in order to access data or programs. Example computer networks may include a single internet connected computer (e.g. an individual's home computer), a corporate computer network containing multiple computing devices and servers across a plurality of locations, or a dedicated server farm. Any given computer network, or portion thereof, may be defined, within the bounds of the present disclosure, as a ‘public’ computer network (or potion thereof) or a ‘private’ computer network (or potion thereof). ‘Public’ means there is no protection necessarily afforded to the data from the public computer network by the present disclosure, ‘private’ means there may be protection afforded to the data from the private computer network by the present disclosure. An example of a public computer network is the wider internet in general, and an example of a private computer network is a home or work Local Area Network (LAN).

Examples of the present disclosure may be agnostic as to where the data is from per se, and examples may in fact protect any predefined (up to and including all) data on a computing device—such data may be merely referenced as ‘Digital Data’. Thus, Digital data is data that is accessed on a device such as a PC, Laptop, Phone or tablet. Digital data is data that may be stored anywhere on a public or private network, or on any digital storage device capable of storing data in a digital format, such as an internal hard drive, optical drive, external hard drive, usb stick, or the like. Digital may be of any type of media such as but not limited to, text, image, audio or video.

The term ‘security layer’ as used herein refers to any entity (software or hardware, or a mixture of the two) that can be used to prevent unauthorised third party access to digital data or programs stored locally on a remote computing device, or on a computer network to which the remote computing device is connected.

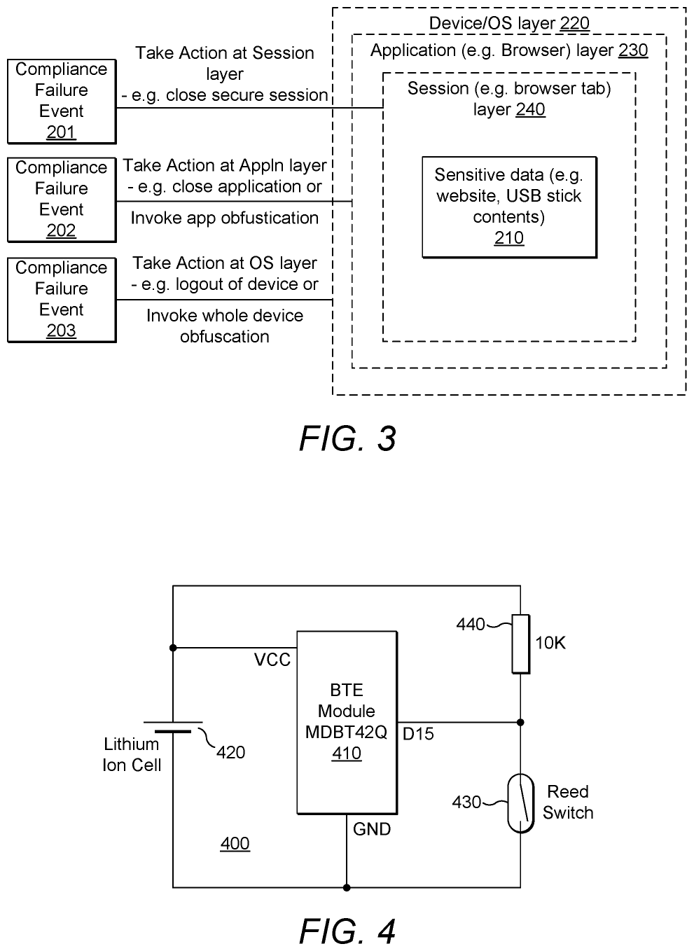

The disclosed examples of security/safety provided by the present disclosure may be applied (i.e. implemented) at different ‘layers’ of the application stack in a computing device, where the application stack is formed of different layers (hardware, and/or software) that build up from the base hardware, through the operating system, then administrator level software, and up into the user level software. In the following detailed description, only some of the example layers may be described, for example (with reference to FIG. 3):

The ‘device/OS layer’ as used herein refers to a specific form of security layer implemented at hardware, or more typically, Operating System (OS) layer of the remote computing device. Thus, examples at this layer operate at the base access level for the hardware (such as, for example, the display screen of the remote computing device, or the like), and can be arranged to do pretty much anything in order to provide the disclosed protection (e.g. provides bespoke obfuscation types, provides fully granular application, etc). Using device/OS layer security may provide the most secure, safe, and adaptable, environment, because there is free-reign to implement any desired form of protection of the digital data from an unauthorised third party (security aspect), as well as any form of protection of the unauthorised third party from the data (the safety aspect).

The ‘application layer’ as used herein refers to a specific form of security layer implemented by a dedicated, and typically proprietary, application (also referenced as simply an ‘app’, especially in the mobile operating system space—iOS, Android, and the like). This may be an application with admin rights, or merely user rights, according to different examples. A typical example may be a dedicated secure software browser installed on the remote computing device. Such a secure browser layer may be referred to as a secure web browser. An authorised user may be required to download and install the secure web browser (or update thereto) on a remote computing device provided by themselves, or it may be pre-installed on a remote computing device provided by a relevant authority, such as employer, workplace or the like. Use of the secure web browser may be mandated (and enforced by computer policy) when access to a particular set of digital data, computer network, or a particular data set or set of programs are in use on the remote computing device. An advantage of using a secure web browser over a standard browser is that it may provide the ability to close any and all instances of the secure web browser during use (i.e. multiple sessions—see below), if a physical security breach is detected, whilst still allowing access to non-secure data on the remote computing device through the standard browser. For example, an authorised remote worker may use the secure web browser to access the third-party-sensitive digital data and/or programs on the work computer network or hard disk space, and a normal browser to access publicly available internet-sourced data that is useful during the work involved on the sensitive data, or that is just used during any downtime from actually working.

The ‘session layer’ refers to any individually addressable and containerizble entity operating within the application layer, that can be individually actioned upon, in particular closed, obfuscated, or to which any other means to prevent unauthorised access may be applied. Examples include browser sessions, tabs, and the like.

The term ‘security monitoring module’ as used herein refers to hardware and/or software modules suitable for monitoring one or more aspects of the remote/home working environment around a remote computing device during use by an authorised user. In some examples, the security monitoring module may include one or more contact sensing devices (e.g. mechanical or magnetic switch, optical switch, or the functionally equivalent).

In the following, a potential security (or safety) risk of access by any unauthorised third party may be any form of unauthorised or undesirable third party access to the digital data, programs, instructions or any other part of the software environment of a remote computing device. This particularly includes being able to visually see the data contained on or in a remote computing device at a distance. Any detected potential security (or safety) risk of access may be called a ‘compliance failure’.

The digital data stored on or in, or otherwise accessible by, a remote computing device according to the present disclosure may be any form of ‘sensitive data’, and may be categorised or defined in a variety of ways depending on the nature of the data, for example it may be personally identifiable information that should be protected from disclosure in accordance with GDPR, it may be considered to be sensitive financial or medical data subject to various regulations, it may be confidential or proprietary data, or it may be considered to be data that it harmful if viewed by unintended third parties. However, during use of the disclosed security provisions, a user may also access data that is not sensitive at all, and therefore does not need any protection applied. An example of this scenario may be where an employer does not care about the data from the wider internet being accessible by another person in the homeworker's house (e.g. content of a public website), but they do care about access to a work provided database of sensitive content data, which they are legally liable to protect from unauthorised third party access even though the user (i.e. worker) is remote working at home).

According to examples of the present disclosure there is provided a computer security (or safety) system suitable for aiding the maintenance of a secure and safe remote/home working environment around the remote computing device, and thus help prevent access to and/or viewing of sensitive data on the remote computing device (i.e. data that have been pre-determined to be sensitive to third party access). There are two primary use cases—the protection of individuals from viewing inappropriate and potentially psychologically damaging content, and an accidental security data breach by way of an unattended device left open/unlocked. The disclosed computing safety system provides both—including: 1) additional safety to the individuals not authorised to view that data displayed on the remote computing device, when third parties enter what is meant to be a safe working environment for the remote computing device; and 2) the disclosed system also aids security of sensitive data from third party access when an employee leaves or changes their working environment by way of exiting the room they are working in, or opening a window.

Some examples may provide hardware security monitoring modules that take the form of one or more magnetic contact sensors that may be fitted to a door/window, or multiple doors/windows surrounding a remote computing device, so that should any given door or window be opened while the remote computing device is operational, then suitable action may be automatically taken to make that remote computing device safe from third party viewing, such as log off or shutdown (of the entire computing device), log off or shutdown or obfuscation (or obfustication in alternative spellings) of a dedicated application in use, for example a dedicated web browser, or session therein (e.g. tab) and/or any other action definable and operable to provide an increased (up to and including total) security or safety of the data deemed sensitive to third party access (e.g. change display settings, such as brightness/contrast, show a warning image, or even encipher the display).

Examples of the sorts of data or programs that may benefit from the security provided by the disclosed computer security system and methods include but are not limited to any one or more of the following: illegal content, personal data as defined under GDPR (“Personally identifiable information (PII)”), confidential, corporate or industrial data such as banking information, or data that should be restricted for a myriad of different reasons, and the like. In effect, the present disclosure may provide security to any data (including executable programs) that is pre-defined as being data that should be secured when a given remote computing device is accessing, or able to access said sensitive data (i.e. data deemed to need securing).

Examples of personal (user) data may include, but is not limited to any one or more of: individual contact information, genetic or biometric data, personal financial information, information pertaining to an individual's religious or political beliefs, data concerning physical or mental health, and other similar information. Such personal (user) data may be defied as any data to which a person or entity may be readily identifiable. Also, such data may have a legal standing that sets out that it is deemed personal (user) data, and therefore should be secured.

Examples of Corporate or industrial data may include, but is not limited to, any one or more of trade secrets, proprietary knowledge, client lists, financial information, or similar business-related data, but may also include data used to drive business or industrial systems, such as control data (for controlling one or more external devices) and the like. Examples may include the data used to drive machinery in a factory, or power plant, or the data that defines an industrial product or service, for example control interfaces for factory machinery, power station management systems, control for surveillance devices, traffic management systems, remote vehicle control, or similar.

Examples of the sort of data that should be restricted for a myriad of different reasons may include data unsuitable for certain age groups (e.g. may include visual or audible content involving violent or sexual imagery, where exposure to said content could have adverse mental or psychological effects on an unsuitable viewer), and the like.

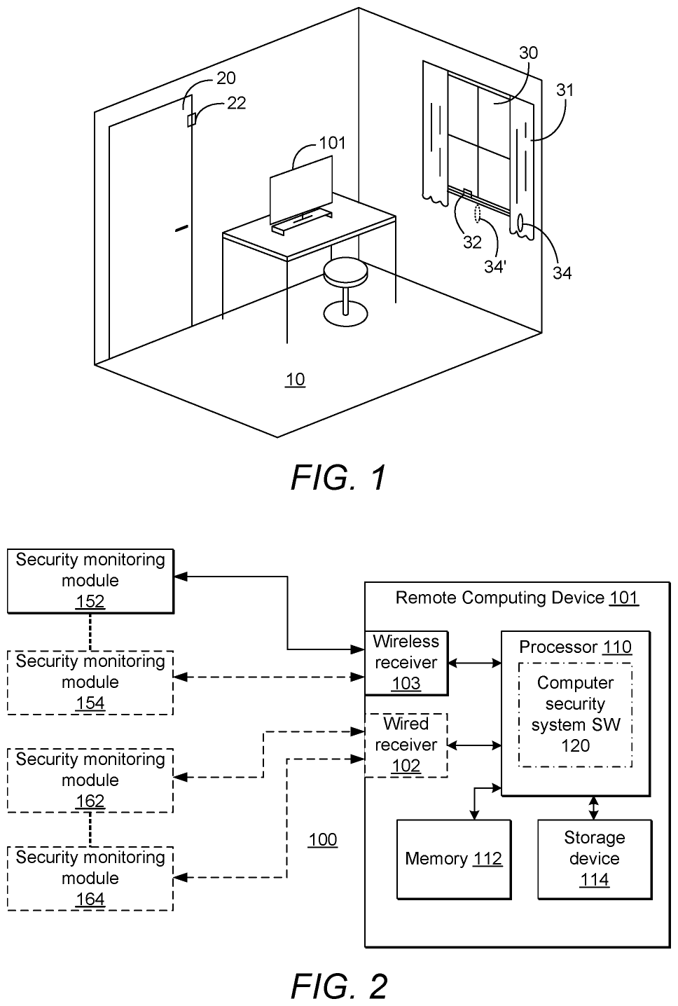

FIG. 1 shows an example arrangement of a remote/home working environment around a remote computing device 101 in which the computer security and/or safety system disclosed herein may be applied. The remote/home working environment shown comprises a room 10, in which a remote computing device 101 is located. The remote computing device 101 is capable of displaying any form of the sensitive digital data to which the present disclosure applies, wherever that data may be stored (local storage device, on the wider internal network, through a VPN connection to an office etc). In the example shown, there is access to the room 10, and hence potential for a physical security breach that may lead to potential visibility by unauthorised third parties of the sensitive data displayed on the screen by way of a door 20, and a window 30 (including associated covering 31). However, in order to secure the data, there are provided suitable security monitoring modules—for example door security monitoring module 22, window security monitoring module 32 and covering security monitoring module 34/34′, where a covering is anything operable to cover an entrance to, or orifice in, (e.g. door, window, window in door, etc) the location around the remote computing device under protection of the disclosed computer security system, and which affords a level of protection against visual access to the displayed data when in one position (i.e. closed), such that when the covering is removed, or otherwise opened, there then exists a security and/or safety issue. Particular examples include, but are not limited to: curtains, blinds, and the like. In the specific example shown, the covering is a curtain, and note, covering sensor portion 34′ is shown as a dashed line, since the curtain is shown in an open state, unlike the other two sensors in the example shown). In summary, a security monitoring module may be provided, suitably formed and arranged to attach (either on, or nearby) to any item that may be deemed a security or safety risk, and that is operable to detect when that item is in a security/safety risk state.

All these different types of security motoring module(s) are operable to detect the opening of the door, window and covering, respectively, and communicate these actions to the remote computing device 101, or a device attached to the remote computing device (e.g. USB receiver), so the remote computing device 101 can take suitable action to prevent third party access to the sensitive data, especially that which is displayed. As such, there is provided mitigation against these potential physical security/safety breaches.

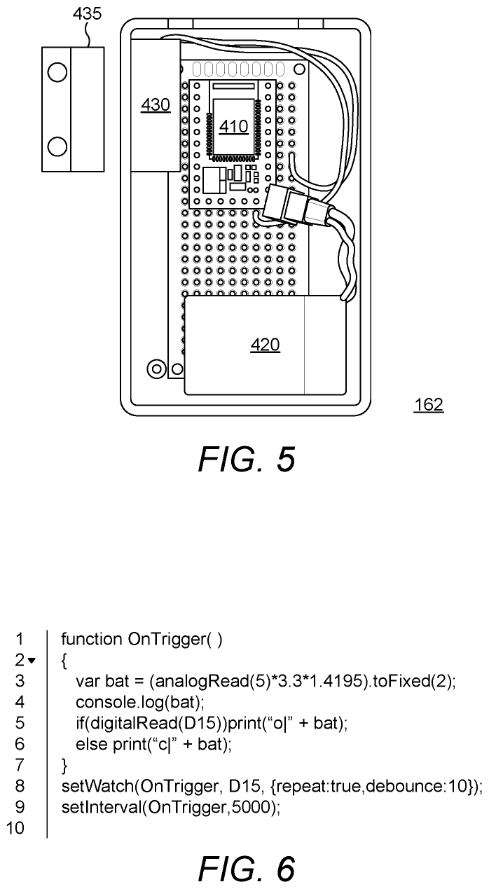

In terms of the covering sensor arrangement, the two portions of the sensor (e.g. the magnetic sensing portion and the fixed magnet portion, e.g. in a holder, as shown in later figures and detailed below) may be attached to the wall and covering, such that the two portions are aligned when the covering is shut, and not aligned in any other covering opening configuration, and hence the open or close state of the covering may be detected, in the same way as the door open or closed state may be detected by the later described example security monitoring modules (See FIG. 5, for example).

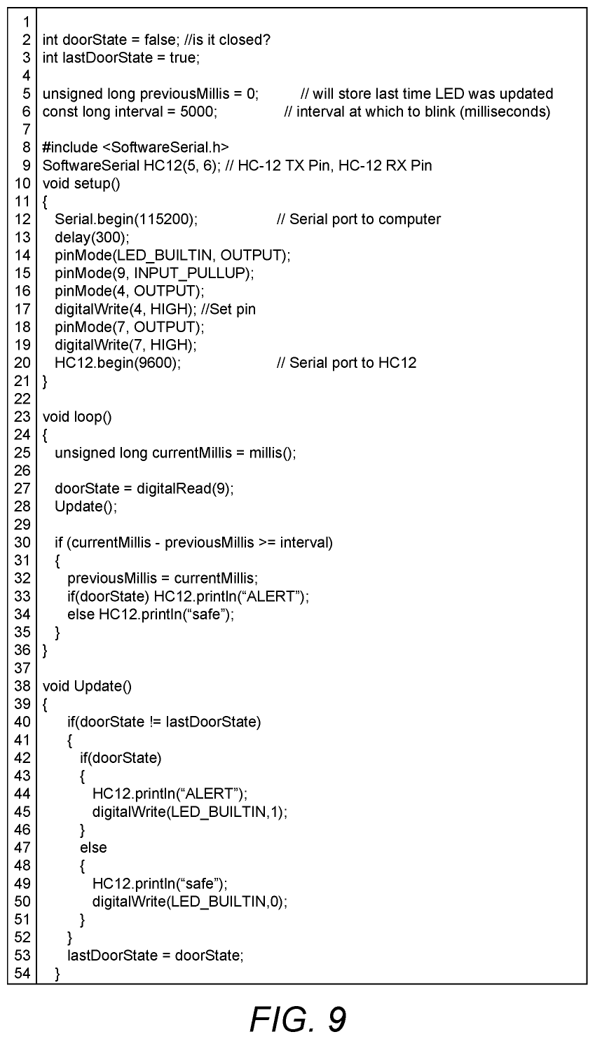

FIG. 2 shows a high level schematic diagram of a computer security system 100 according to an embodiment of the present disclosure. In the example shown in FIG. 2, the computer security system 100 comprises a remote computing device 101 for use in accessing sensitive data, and at least one security monitoring module 152. In this case, the security monitoring module 152 is wirelessly connected, as will be described in detail below (with reference to FIGS. 4, 7 and 8), but the system may comprise any number of wireless modules, and wired modules may also be used. These are shown in dotted lines, and comprise wireless security monitoring module 154, wired security monitoring modules 162 and 164. The remote computing device 101 includes a wireless receiver 103, which may be any suitable form of wireless communication device, for example Bluetooth or other RF device. Where the remote computing device 101 implements a (fully or partially) wired system, then the remote computing device 101 may include a suitable wired receiver module 103, for example a Universal Serial Bus (USB) module. The remote computing device 101 also comprises all the usual computing components, such as processor 110, memory 112 and at least one local storage device 114, all operable together to implement the software portions (or implementations) of the disclosed computer security system, as discussed in more detail below with reference to FIGS. 6 and 9. These are shown conceptually as the dot and dashed lined item 120. Processor 110 shown is operably coupled to memory 112 and local storage device 114, such that they may interoperate using instructions, commands, and the like to carry out the computing processes used during normal operation of the remote computing device 101, as well as the use-specific computer processes that enable an authorised user to access ‘deemed’ sensitive data, whilst preventing unauthorised third party access. Processor 110 is operably coupled to the wired receiver 102 (where applicable), and operably coupled to the wireless receiver 103 in more typical examples that make use of wireless communications, to communicate with the security monitoring modules. Processor 110, in operation, is configured to run an operating system, which may run or otherwise execute secure programs for use with the disclosed computer security system, such as those in the ‘device/OS layer’, ‘application layer’ or ‘session layer’.

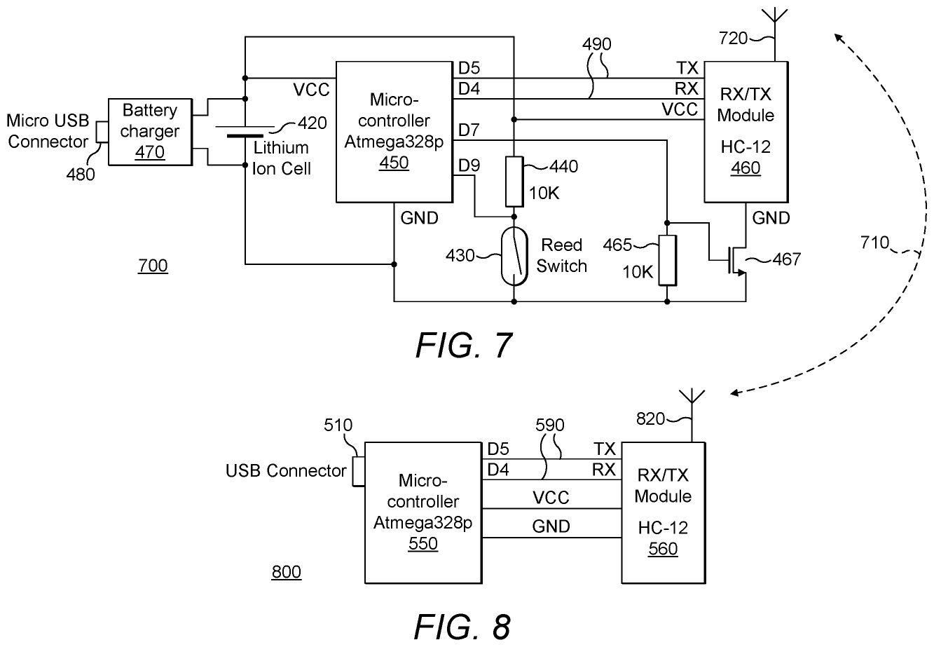

The one or more wired security monitoring modules 152, 154 (where applicable), may be communicatively coupled to processor 110 via a wired interface, such as, but not limited to a serial, parallel, or USB interface. Dedicated, bespoke, wiring may also be used. The one or more wireless security monitoring modules 162, 164, may be wirelessly connected via any suitable wireless protocol, suitable for communication with the remote computing device through various standard communication protocols. These communication protocols may be wired or wireless. For example, Bluetooth Low Energy (BLE) may be used (see FIG. 4), or 433 MHz Wireless Serial Port Communication (see FIGS. 7 and 8). In some examples, a Bluetooth Low Energy module or a 433 MHz Wireless Serial Port Communication module may be installed within the remote computing device. In some examples, one or both of the Bluetooth Low Energy module or the 433 MHz Wireless Serial Port Communication module may be connected to the remote computing device by an external connection, such as a Universal Serial Bus (USB) connection or similar.

In some examples, 433 MHz Wireless Serial Port Communication may be used instead of Bluetooth or Bluetooth Low Energy, in order to benefit from the increased signal range of 433 MHz Wireless Serial Port Communication compared to Bluetooth or Bluetooth Low Energy.

It should be noted that all security monitoring modules may be connected via USB receiver 102, or all security monitoring modules may be connected by wireless receiver 103, or some combination thereof, or by any other means to enable communication from a security monitoring module to/from the remote computing device 101, for the purposes of informing the remote computing device of a physical breach of the security of the remote computing device, and the described configuration of FIG. 2 is by way of example only.

A legitimate user wishing to log on to the remote computing device 101, in order to interact with and otherwise access the sensitive data being protected by the computer security system 100 as disclosed herein, will verify that physical access security (as discussed above) to the remote computing device is safe and secure. According to the disclosed examples, this verification of the physical security may be done by setting up and using one or more of the security monitoring modules on each door and/or window (or equivalent access means), so they can detect any breach in, or physical access to, the remote/home working environment 10 that is undesirable. Then, in order to open the respective software client (i.e. the secure browser, the secure tab, or just log into the base device/OS), the user will need make sure that all the security modules are in their “safe” setting (e.g. sensors are in a ‘closed’ position) and hence the remote/home working environment 10 is known safe and secure. In this way, the disclosed computer security system provides a ‘fail safe’ approach to the safety of the remote computing device and/or the data and programs contained therein (or connected thereto). This ensures that the remote computing device has a suitable level of physical safety in place before a person starts work on any sensitive data.

When the authorised user is accessing the sensitive data on the remote computing device, for example via any one (or more) of: via the remote computing device 101 generally (i.e. at device/OS level), via a dedicated application (e.g. secure web browser), or via a secure session in a normal browser, then the one or more security monitoring modules 152, 154, 162, 164, are used to monitor for any breach in the data security, by way of any of the doors or windows being opened. If, at any time, one of the one or more of the security monitoring modules 152, 154, 162, 164, detects such an opening, this is indicates that the user's remote/home working environment is no longer in compliance with the required security and or safety considerations and so suitable preventative action can be taken to obfuscate the data until such time as the breach is no longer detected.

FIG. 3 shows a schematic diagram of how a portion of the disclosed computer security system may be implemented in different layers of a remote computing device according to an embodiment of the present disclosure and provides some examples of different means to protect the data resulting therefrom. As shown in FIG. 3, the sensitive data 210 being protected by the disclosed computer security system resides in a place accessible by any of the layers—in this case, any of the device/OS layer 220, the application layer 230 or the session layer 240. When a respective compliance failure event (i.e. one or more of the security modules determines a respective door or window has opened, or similar/equivalent security or safety breach event has occurred), then action can be taken in the respective layer in which the computer security system is implemented. For example, for a compliance failure event 201 at the session layer 240, then the respective session (e.g. browser tab, or the like) can be closed, in order to secure the data and provide safety to the unauthorised third party. In another example, for a compliance failure event 202 at the application layer, then the respective application (e.g. secure browser) can be closed as whole, or otherwise the whole application can obfuscated (e.g. displaying a warning/image over the entire screen), in order to secure the data and provide safety to the unauthorised third party. For an example implemented at the device/OS layer 220, then when there is a compliance failure event 203, then the whole device may be logged out, or a whole device obfuscation method may be applied.

Implementations at the device/OS layer 220 may comprise the remote computing device, such as a desktop computer, laptop, tablet computer, or smartphone merely including hardware that can emulate basic functions that can provide the requisite level of obfuscation. In such examples, in response to receipt of a signal indicating a compliance failure event by one or more safety monitoring modules, the remote computing device may be locked, logged out, forced to shut down, or the screen blanked. Locking, logging out, or shutting down of the remote computing device allows for any device application 232 to be closed, even those that run outside of a safe web browser instance, as well as closing of alternative (non-safe) browsers 234, and preventing access to on-device files 236. In these device/OS level 220 implementations, the hardware may simply provide keyboard emulation, so that basic OS shortcuts can be used to carry out the action—e.g. a USB hardware module (e.g. USB dongle) including the RF receiver to receive status messages from the security monitoring modules, and a microcontroller to process and action those messages, can be arranged as a USB Human Interface Device (HID) that can emulate a keyboard outputting known Windows™ shortcuts, such as (Windows key+L) to lock the device (or Mac, or other OS equivalent commands). A benefit of such an implementation is it would not require any software running on the remote computing system other than the OS (needed anyway), and if the USB dongle is programmed to output more than one command, or detect the OS on first boot up, then the same dongle can work for any and all likely OSes in use.

Additionally, a fully controlled dedicated hardware device may allow an employer or administrator to control which applications and/or software are installed on the hardware device, and may allow an employer or administrator to delete sensitive information from the device once the user has completed a set task requiring the sensitive information.

In implementations at the application layer 230, the respective application may be a secure web browser, or other dedicated software. The secure web browser may be downloaded and installed on the remote computing device. In some examples, receipt of a signal indicating a compliance failure event by one or more security monitoring modules may close all running instances of the secure web browser.

In some examples the secure web browser may be a proprietary secure web browser, which may be based on an open source web browser, such as Chromium, Firefox, or similar. In some examples the secure web browser may be a standard web browser modified by means of a plugin, extension or add-on, whereby the plugin, extension or add-on has sufficient permissions to close all instances of the secure web browser in response receipt of a signal indicating a compliance failure event by one or more security monitoring modules. In some examples, a plugin based implementation may only provide a session-level 220 based solution. In some examples, previously open tabs and/or web applications may be re-opened when a user logs in to the secure web browser again following appropriate verification measures and/or verifying that the physical access environment is secure. In some examples, closing the secure web browser may comprise disabling the secure web browser by making content in the secure web browser no longer visible, but without closing the secure web browser instance. In some examples, the secure web browser of application layer 230 may be further operable to control website access, either through permitting access to only certain websites, or through a blacklist preventing access to certain websites.

There will now follow detailed description of two example implementations of the security monitoring modules of the disclosed computer security system. The difference is in the radio frequency technology used to implement the wireless link(s) between the respective security monitoring module(s) and the remote computing device under protection of the disclosed computer security system. The remaining portions of the security monitoring module(s) and remote computing device(s) that are not explained in more detail as being different may be assumed to be generally the same, similar or equivalent and in that respect, the different embodiments may be mixed in any given specific implementation. In particular, a given implementation of the disclosed technology may make use of both Radio Frequency (RF) systems to provide cross compatibility, or to leverage the benefits of each RF technology for certain situations, for example range (from using the 433 Mhz RF technology) and usability with multiple devices without a dedicated dongle on one or more remote computing device(s) (from the Bluetooth BLE technology).

Both the disclosed examples use the same magnet and reed switch arrangement to detect the open/closed state of a doorway or window to which the security monitoring module is attached, but the method of communication between a given security monitoring module and a respective remote computing device (i.e. the user's computer/tablet) may differ in order to cover both short- and long-range situations. It will be appreciated that a respective security monitoring module comes in two parts that work together in the same location—the electronics portion, including reed switch magnetic sensor, and a permanent magnet portion that operates with the reed switch to sense an open or closed status of a respective door or window (or even covering). The two portions merely need to be physically located in such an arrangement that the magnet is on one part of the door/window/frame and the electronics is on the other, so that when a door/window/covering opens, the magnet moves away from the magnetic sensor, resulting in an output signal change.

As noted previously, a given implementation is capable of having multiple devices (both multiple security monitoring modules to provide the protection, and multiple remote computing devices being protected), but in any implementation involving BLE, the number may be limited to the number of Bluetooth connections the receiving device (i.e. remote computing device) can handle. In cases where there is a limit that impinges on proper and full use, then an additional BLE module may also be used to increase the number of Bluetooth devices that can be used, as would be appreciated by the skilled person.

FIG. 4 shows a circuit diagram 400 of a security monitoring module implemented using Bluetooth Low Energy according to an embodiment of the present disclosure, for example as could be used to provide module 162 of FIG. 2. This BLE based version may be the simpler of the two versions in terms of the hardware used at the security monitoring module side, since there are combined microprocessor and BLE System on Chip (SoC) modules commercially available that may be used, or at least SoCs including enough processing power to enable to the functions used in the present disclosure (for example the MDBT42Q module by Nordic Semiconductor/Espruino, which includes a JavaScript interpreter). The SoC may be packaged as a module that includes all the ancillary components needed for normal operation, and may include a reset button and high efficiency voltage regulator that allows higher input voltages to be used, e.g. from a lithium cell battery, which may provide longer service life that other battery technologies.

In FIG. 4, the BLE module 410 is operably coupled to a lithium ion battery 420 (e.g. a 500 mAH single cell lithium ion battery) to provide power (VCC/GND), and a reed switch 430 and pull up resistor 440 in a voltage divider configuration across the power rails (VCC/GND), which acts as the magnetic sensor to determine whether a permanent magnetic (not shown) is present nearby, as per typical magnetic door sensor operation. In the example shown, the pullup resistor 440 holds pin D15 high, but when a magnet holder 435 is brought near to the reed switch 440, the input D15 to the controller is pulled low. It will be appreciated that in some implementations, the polarity of the operation may be reversed (i.e. the input is pulled high instead).

The example shown uses a 500 mAH single cell lithium ion battery, which due to the extremely low power usage of the BLE module used is capable of lasting several months. However, with larger batteries, it is quite possible to have a system that would only need charging/replacing once per year, or less.

FIG. 5 shows a full physical implementation of the security monitoring module of FIG. 4, which particularly shows how the BLE module 410, battery 420 and reed switch 430 may be physically configured inside a box that may be applied to a respective door or window (frame or door/window itself), and the permanent magnetic holder portion 435 placed near the reed switch 440, relative to the overall security monitoring module. This figure shows how security monitoring modules 122-164 of FIG. 2 may be implemented.

The BLE module 410 typically includes an operational firmware, and this may be configured to use a twofold approach, in order to respond as quickly as possible to a change in environment security around the remote computing device(s) under protection of the security monitoring module, during use.

The first portion of the approach may be an instant response on a change in environment security, as detected by the reed switch 430/permanent magnet 435 arrangement. That is, when the permanent magnet attached to either the door or frame is moved away from the reed switch (which is located on the other one of the door or frame), thereby causing the signal at pin D15 of FIG. 4 to switch from high to low, then the BTE module 410 determines the door is opened, and forms a suitable message that can be sent over the BLE link, back to the remote computing device(s) under protection of this particular security monitoring module. On receipt of this message, the remote computing device(s) may then invoke a suitable response, such as obfuscation of the screen (or application, or session), or causing it to be locked/disabled, or the like.

The second portion of the approach may be a heartbeat message, which is a message that is sent at a regular interval (e.g. 5 seconds=5000 ms) that announces to the receiving remote computing device(s) the state of the security monitoring module. This allows the receiving remote computing device(s) to automatically lock (or otherwise obfuscate the display) if a respective security monitoring module is turned off, or otherwise disabled in some way, thereby stopping the regular sending of the heartbeat message. This may occur in particular when the battery powering the security monitoring module runs out of power, but also covers malicious removal or disablement of the respective security monitoring module. In some examples, this heartbeat message may also contain the battery voltage, so that the user can be warned well before the situation of the battery running out of power arises, and so the user can be warned it is time to change/charge the battery. In some examples, the heartbeat message, or indeed other alternative or additional messaging used in the disclosed system, may also provide further system health information, such as, but not limited to health metrics about: duration of operation (total, since last reset/battery change, and the like); a number of times an opening of a respective security risk has been detected to date, or the like; battery power levels; signal power or other signal quality parameters (i.e. regarding the quality of the communication links between the different security monitoring modules in use to protect a respective remote computing device, during use, for example to aid optimised placement of the respective security monitoring modules). Provision of such health metrics would provide the capability for the remote computing device to indicate to a user or administrator of the system the current statuses of the computer security system, for overall monitoring, fault finding, improved initial setup, and monitoring of continued proper use.

In examples where the BLE Module 410 includes on-board processing means, such as a JavaScript Interpreter, this inclusion may allow the firmware to be programmed and updated over the Bluetooth connection itself. It will be appreciated that other implementations may use a separate, simpler, BT module together with independent processing means, such as a microcontroller module (in line with that shown for the below RF version of FIG. 7).

FIG. 6 shows example pseudo code of a portion of the proprietary aspect of the firmware for use with the security monitoring module of FIG. 4. As can be seen, this shows a top potion that detects the operating voltage of the battery, reading out and sending to the remote computing device inside a BTE message, as well as a lower portion that is a debounced watch trigger based approach to detecting a change in the voltage seen on the input pin D15, in order to determine an opening (or closing) event, from which the remote computing device may action a suitable response, such as any form of obfuscation of the respective remoting computing device's screen. A final portion sets the 5 second heartbeat period.

Accordingly, once triggered either by the (5 s) timer, or the interrupt from the reed switch changing state, a message is built containing the switch state, and the battery voltage.

FIG. 7 shows a circuit diagram of a security monitoring module implemented using 433 MHz RF technology, according to an embodiment of the present disclosure, and may be used when a longer range is preferable. For example, where the relatively short range of Bluetooth Low Energy would not be sufficient, or the number of devices is greater than the BTE system can handle. In this respect, although the maximum range of BTE is stated to be 100 m, this is only with perfect conditions and no obstructions e.g. outdoors. In practice, indoors the range is in the region of 20 metres or so, maximum, which may be sufficient if the environment to the secured is only one room, or a small building, but may not be in all use-scenarios, especially since the present disclosure is about securing indoors environments. For example, for any implementation that could use greater range, or if there is a lot of interference from Wi-Fi networks/mobile phones (which share Bluetooth frequencies) in the building or room under surveillance, then the 433 MHz Radio frequency system would give much greater reliability, albeit at greater hardware cost, and complexity. In the RF 433 Mhz example shown, the system in use has a theoretical range of up to 1 Km and has an unlimited number of devices that could be connected at the same time.

The long-range system comprises of two parts, unlike the BTE example of FIG. 4—the remote sensor portion 700 as shown in FIG. 7, and a receiver dongle 800 to connect to the respective remote computing device as shown in FIG. 8. This is because most remote computing devices do not provide any inbuilt 433 Mhz RF circuitry. However, some embodiments of the disclosure may include dedicated remote computing devices for use in such a system that include the 433 RF circuitry as well. This would avoid the need for a separate receiving dongle per se.

The disclosed example uses a microcontroller (specifically an Atmel AVR ATMega328p microcontroller solution) and a 433 MHz serial radio transceiver module (specifically an HC-12 module) in both the transmitter and receiver parts of the system implementing the two portions of the two part 700/800 RF based security sensing module system. The two are connected together by RX/TX (i.e. transceiver—any and all instances of RX/TX in the present description are considered transceivers) signal lines 490, so that messages formed by the microcontroller 450 can be sent in serial form to the RX/TX module 460, for transmission out, and signals received by the RX/TX module 460 can be passed to the microcontroller 450 (this may be used for updates to firmware and functions during deployment).

Again, the remote sensor portion 700 incorporates a lithium ion battery 420, as well as a charging module 470 that can charge the battery off a USB connection 480, when it is connected to USB port that can provide power. Any other form of charging mechanism may be used instead or as well, as would be appreciated by the person skilled in the art. The remote sensor portion 700 also includes a switch 467 (MOSFET in this example, but other suitable switching means may be used instead) to power off the radio module 460 when it is not being used, in order to conserve power. The RX/TX module 460 is coupled to an antenna 720, for transmission of signals, and the usual power supplies (VCC/GND)

In the example shown in FIG. 7, the MOSFET 467 is controlled by another resistor divider, using a pull-down resistor 465, connect between 0V/GND, and an output pin of the microcontroller (D7, in this example). The remaining portions of the circuit, in particular the reed switch arrangement (reed switch 430 and pull up resistor 440) is the same as used on the previous example of FIG. 4, and may also be reversed in operational polarity (i.e. the pull up/down action may be reversed).

During operation, the input D9 to the microcontroller from the reed switch arrangement is operational to detect the change from high to low, thereby indicating to the microcontroller 450 when the magnetic switch is opened, and hence the door or window to which the security sensing module (or transmitting portion 700 thereof) is attached is open. When this occurs, the microcontroller is operably arranged to form a message to send over the RF link, via Rx/TX lines 490 (in particular, sent over the serial transmission line D5) to the RF RX/TX module 460 operating in TX mode. Meanwhile, output D7 is held high at the times when transmission (receiving or transmitting) is needed, which turns on the MOSFET 467, thereby powering on the RF RX/TX module 460. At other times, this may be powered down. This power efficiency improvement is advantageous in non BTE implementations, because the RF circuitry for 433 MHz operation is not typically natively as low powered as the BTE implementations, but can be powered down when not in use to eke out greater service life. The period when the RX/TX module is powered down may also be programmatically synchronised with the heartbeat signal rate, so that the module is on for those periods, and off else times, unless an opening event occurs.

Transmissions are sent from the transmitter module 700 to the receiver module 800, via antennas 720/820, as shown by arrow 710.

The receiver module 800 uses the microcontroller 550 as a simple serial message repeater. This is to say, messages received in serial form from the transmitter module 560 to the microcontroller 550 over TX/RX lines 590 are passed on through the microcontroller 550, out to the remote computing device to which this receiver portion 800 is attached, for actioning the suitable response (turning on or off the obfuscation of screen, etc). Meanwhile, the microcontroller 550 is couplable to the remote computing device (not shown) via a USB interface 510, which may be provided by the microcontroller module 550 itself, or may be implemented independently, as would be appreciated by the skilled person. In the example shown, the output from the USB interface would appear as a USB Serial (COM) port, ready for use in software running on the remote computing device to action, as per FIG. 9.

The overall receiver portion 800 could be small enough to be built into a USB flash-drive sized dongle.

FIG. 9 shows example pseudo code for use with the RF based compliance monitoring module of FIGS. 7 and 8, according to an embodiment of the present disclosure. This pseudo code may be executed by the microcontrollers 450/550, as appropriate, and as would be appreciated by the person skilled in the art. In this example pseudocode, the long-range prototype works in almost the same way as the BTE version described above, with instant messages being sent in serial form over the RF communication links provided by the two HC-12 modules either end, when triggered by environment change, as well as providing a similar the heartbeat message to ensure that the devices are working properly and the battery levels are sufficient.

Moreover, the microcontrollers 450/550 may also be put to sleep between messages in order to save power. In which case, the respective microcontroller(s) may be woken up on an interrupt from the reed switch. This approach, in combination with the ability to switch the radio module off as noted above, provides a very long battery life for the overall system implementing the split RF module version (as per FIGS. 7 and 8) despite the relatively high power use of the respective portions of each module (the microcontroller 450/550 and RF RX/TX modules 460/560 respectively).

As will be appreciated, examples of the security monitoring module may comprise one or more contact devices in order to ensure that doors and/or windows in the working environment are closed and/or appropriately secured. The contact device may take the form of a magnetic proximity sensor, such as a reed switch or Hall effect sensor, where the magnetic sensing element is paired with a magnet on the opposing part of the door or window (e.g. the magnet is on the door and the sensor on the frame, or vice versa). Alternatively, the contact device may take the form of a physical contact sensor, requiring a conductive element on each part of a door or window, whereby contact between the conductive elements indicates that a door or window is closed, and lack of contact between the conductive elements indicates that a door or window is open. The described contact devices are intended by way of example only, and it will be understood that a range of similar appropriate contact devices suitable for monitoring doors and/or windows are envisaged. In some examples, a security monitoring module may comprise more than one contact device used in combination. Alternatively, optical sensors, or Passive InfraRed sensors arranged in a simply ON/OFF (heat signature present or not) may equally or additionally be used.

In some examples, the security monitoring modules may be built into the respective door frame and door itself (or window/window frame), so that there is no visibility of the presence of the disclosed computer security system.

In some examples, the contact device security monitoring module may be configured to send an alert signal to a receiver connected to the remote computing device only when the contact between the two parts (i.e. sensing element and magnet) of the contact device is broken (e.g. indicating that the door/window is open). In some examples, the contact device security monitoring module may be configured to send a ‘heartbeat’ signal (i.e. an ‘all okay’ update signal) to the receiver periodically (e.g. every 2 seconds). This ensures that the receiver knows that the security monitoring module is active and has not simply run out of power, been switched off, disconnected, or otherwise disabled. In some examples, the receiver may poll the contact device security monitoring module periodically during use to verify that the contact device is active, in order that the security monitoring module need only provide a return signal in response to a poll from the receiver when the remote computing device is active, to reduce power consumption.

An example security monitoring module may comprise one or more sensors in order to detect the opening of doors, windows, coverings, blinds or similar in the physical access environment. For example, where the remote computing device is located near a window and thus there are privacy concerns due to the potential for viewing secure data or programs through the window by a third party (i.e. an unauthorised user), a remote access policy may require the user to keep a covering (e.g. curtain or blind) closed during use. Accordingly, a security monitoring module may be fitted to said covering or blind to ensure that said covering or blind is not moved from a closed position after commencing work and therefore potentially allowing unauthorized third party to view sensitive data.

In some examples, multiple remote computing devices may be connected to a common set of security monitoring modules (e.g. multiple contact devices), for example where a single user has more than one remote computing device (e.g. a laptop and a smartphone), or where two or more users share a common physical access environment.

The specific combination of the security layer used, and security monitoring modules provided may depend on specific remote access policies enforced by an owner of the computer network, an owner of the sensitive data or programs, an employer, manager or administrator. These policies may vary depending on level of access to the sensitive data by the user and/or the sensitivity of the secure data being accessed.

As will be appreciated, the box containing the electronics (and/or the separate magnet and holder) is readily applied to doors, windows and coverings, on an ad-hoc basis, to secure any room (or equivalent space) in a remote location such as a home. As such, the equipment can be provided by an employer to enable a secure and safe (home) working environment for sensitive roles, such as online moderators, and the like.

The equipment may be provided as a set of hardware modules to install on all access points (doors/windows, etc), optionally one or more hardware modules to attach to the remote computing device(s) being protected, and software to install on the respective remote computing devices. However, implementations that use keyboard emulation may be provided as hardware only, i.e. without dedicated software in the remote computing device.

Whilst the foregoing references Bluetooth LE, and 433 MHz RF communications links for use in long range implementations, any other suitable RF frequencies may equally be used, subject to the licensing and operational requirements of those selected RF frequencies.

Certain aspects of the disclosure described herein may be implemented by a processor, the processor suitable for processing a program(s) that is retrieved from non-transitory computer readable storage medium, for example a pre-programmed firmware or the like. Processors suitable for the execution of computer program code include, by way of example, both general and specific purpose microprocessors, microcontroller modules, application specific integrated circuits (ASIC) or field programmable gate arrays (FPGA) operable to retrieve and act on instructions and/or data from the computer readable storage medium.

The computer readable storage media can be any media suitable for containing, storing, or maintaining computer programs and data for use by or in connection with an instruction execution system. Computer-readable storage media can comprise any one of many physical media such as, for example, electronic, magnetic, optical, electromagnetic, or semiconductor media. More specific examples of suitable machine readable storage media include, but are not limited to, a hard drive (HDD), a random-access memory (RAM), a read-only memory (ROM), an erasable programmable read-only memory (EPROM), a portable disk, or a solid state drive (SSD).

In some examples, the computer-readable storage medium may comprise program code or instructions, for example in the form of a firmware, to perform any of the methods of operating the remote security monitoring hardware, as discussed herein. This includes software or hardware operating in, or connected to, the individual security monitoring module(s), the software or hardware operating in, or connected to, a remote computing device, and/or any overall security system comprising one or more of these security monitoring module(s) or remote computing devices. Embodiments of the present disclosure may include a single security monitoring module operational to connect to a remote computing device, in order to instruct said remote computing device to obfuscate, or otherwise render unviewable, the secure data displayed on said remote computing device during use on said secure data (such an example may use human interface emulation to convey the instruction).

According to a first example there is provided a computer security system comprising: one or more sensors operably couplable to a remote computing device, wherein the one or more sensors are operable to detect a physical security breach of a location where the remote computing device is located; and wherein, in response to detection of the physical security breach by the one or more security sensors, the one or more security sensors are operable to instigate (or instruct) the remote computing device to obfuscate one or more activities running on the remote computing device.

According to a second example, that may be combined with the first example, the one or more activities running on the remote computing device comprise any one or more of: execution of an operating system; execution of an application; and/or execution of session.

According to a third example, that may be combined with any of the two previous examples, the remote computing device is operable to obfuscate the one or more activities by any one or more of: closing the one or more activities; rendering the one or more activities unviewable; and/or providing a visual warning to a user, said visual warning optionally overlaying a display of the one or more actives on the remote computing device. The obfuscation may comprise logging off from the remote computing device, or the application or session thereon, or otherwise locking out access to the remote computing device (or software thereon).

According to a fourth example, that may be combined with any of the previous examples, the physical security breach of a location comprises any one or more of: an opening of a door in the location; an opening of a window in the location; or an opening of a covering in the location, wherein the door or window or covering is operable to secure the location of the remote computing device from access by a third party person (or other item, such as a camera, or the like). Optionally, wherein said access by a third party person comprises the third party person (or other item) being able to view the secure data on a screen of the remote computing device.

According to a fifth example, that may be combined with any of the previous examples, the one or more security sensors are any one or more of: a door sensor, operable to detect the opening of a door in the location; a window sensor, operable to detect the opening of a window in the location; a covering sensor, operable to detect the opening of a covering of a window or door in the location; and/or a movement sensor, operable to detect a presence of a person in the location. The door, window or covering sensor may be a magnetic sensor, a contact sensor (contact switch) or an optical sensor.

According to a sixth example, that may be combined with any of the previous examples, the one or more sensors are provided in one or more security monitoring modules, wherein said security monitoring modules are attachable to any door, window or covering in use around the location of the remote computing device, in order to detect a physical breach of the location in which the remote computing device is located, for example in the sense of such a detectable physical breach being causative of an unauthorized third party (person) being able to see or otherwise access sensitive data that may be a breach of security of said sensitive data, and/or a safety issue, for example capable of causing harm, in particular mental distress, or legal distress/liability, to said unauthorized third party. As such, the disclosed examples may provide a means to ensure legal operation on said sensitive data.

According to a seventh example, that may be combined with any of the previous examples, the one or more sensors are operably couplable, or coupled, to the remote computing device using Bluetooth or Radio Frequency, RF, communications links.

According to an eighth example, that may be combined with any of the previous examples, the one or more security monitoring modules comprises a microcontroller. The microcontroller may be operably coupled to an RF transceiver. The microcontroller may be operably arranged to detect the physical security breach (i.e. opening of a respective door, window, or covering) and transmit a message, via the RF transceiver, to the one or more remote computing devices

According to a ninth example, that may be combined with any of the previous examples, the computer security system may further comprise a plugin module (e.g. USB stick, or the like), that may be logged in to the remote computing device, in order to provide the disclosed functionality. The plugin module may further comprise a second microcontroller operably coupled to a second RF transceiver at the remote computing device side, wherein the second microcontroller is operably arranged to provide a signal to the remote computing device in response to the detection of the physical security breach by the one or more security sensors.

According to a tenth example, that may be combined with any of the previous examples, the first or second microcontroller may be operably arranged to emulate a keyboard output for use by the remote computing device to action the obfuscation of the activities on the remote computing device.

According to an eleventh example, that may be combined with any of the previous examples, in response to detection of the physical security breach by the one or more security sensors, the system may be operable to provide a signal indicating the occurrence of a physical security breach

According to a twelfth example, that may be combined with any of the previous examples, the system may be operable to provide a heartbeat signal indicative of any one or more of: the presence of a physical security breach; the presence of any one or more of the one or more security sensors; a power level state of any one or more of the one or more security sensors, and any other system health metric(s), which may be used to administer, or otherwise operate the disclosed computer security system. For example, to better set the system up initially (e.g. placement of devices/modules), and maintain proper operation during use.

According to further examples, that may be combined with any of the previous examples, the system may further comprise a switch (or multiple switches, as applicable), each switch operable to turn the microcontroller or transceiver on (and off) during use. The switch may be a transistor switch, operating off an output of the microcontroller(s), or any other controller means within the system, in order to provide suitable power control over the respective components of the overall system to which the switch(es) is/are connected.

According to a thirteenth example, that may be combined with any of the previous examples, the system, and/or each independent security monitoring module involved, may further comprise a battery charger, for charging up an internal rechargeable battery.

In the foregoing example, whilst the term computer security system has been used, it will be appreciated that the computer security system may comprise as little as a single security monitoring module, for attachment to a single access point to the working environment (such as door, window or covering). The said single security monitoring module may then utilise Bluetooth LE, or any other commonly used RF technology within a computing device, in order to provide the disclosed protection against unauthorised third party access to the sensitive data, for example by using simple base hardware emulation, such as keyboard emulation. In such a form, the disclosed system is quick and cost effective to provide, install, and, ultimately use.

According to a fourteenth example, that may be combined with any of the previous examples, where appropriate, there is provided a computer security method comprising providing one or more sensors operably couplable to a remote computing device, wherein the one or more sensors are operable to detect a physical security breach of a location where the remote computing device is located, and in response to detection of the physical security breach by the one or more security sensors, the remote computing device obfuscates one or more activities running on the remote computing device.

According to a fifteenth example, that may be combined with any of the previous method examples, the one or more activities running on the remote computing device comprise any one or more of: execution of an operating system; execution of an application; and/or execution of session.

According to a sixteenth example, that may be combined with any of the previous method examples, the method may further comprise obfuscating the one or more activities by any one or more of: closing the one or more activities; rendering the one or more activities unviewable; and/or providing a visual warning to a user, wherein said visual warning optionally overlays a display of the one or more actives on the remote computing device.

According to a seventeenth example, that may be combined with any of the previous method examples, the physical security breach of a location comprises any one or more of: an opening of a door in the location; an opening of a window in the location; or an opening of a covering in the location, and wherein the door or window or covering is operable to secure the location of the remote computing device from access by a third party person.

According to an eighteenth example, that may be combined with any of the previous method examples, the one or more security sensors are any one or more of: a door sensor, operable to detect the opening of a door in the location; a window sensor, operable to detect the opening of a window in the location; a covering sensor, operable to detect the opening of a covering in the location; and/or a movement sensor, operable to detect a presence of a person in the location.

According to a nineteenth example, that may be combined with any of the previous method examples, the method may further comprise providing one or more sensors operably couplable to a remote computing device comprises providing one or more security monitoring modules comprising said one or more sensors, and wherein each security monitoring module comprises a microcontroller operably coupled to a Radio Frequency, RF, transceiver, wherein the microcontroller is operably arranged to detect the physical security breach and transmit a message, via the RF transceiver, to the one or more remote computing devices.

According to a twentieth example, that may be combined with any of the previous method examples, the method may further comprise providing a plugin module to the remote computing device, wherein the plugin module further comprises a second microcontroller operably coupled to a second RF transceiver at the remote computing device side, wherein the second microcontroller is operably arranged to provide a signal to the remote computing device in response to the detection of the physical security breach by the one or more security sensors.

According to a twenty-first example, that may be combined with any of the previous method examples, the first or second microcontroller is operably arranged to emulate a keyboard output for use by the remote computing device to action the obfuscation of the activities on the remote computing device.

According to a twenty-second example, that may be combined with any of the previous method examples, the method may further comprise providing a switch, operable to turn the microcontroller or transceiver on during a period of use, or off otherwise, and/or a battery charger in at least one of the one or more security monitoring modules.

According to a twenty-third example there is provided a computer readable medium comprising instructions, which, when executed by one or more processors, cause the one or more processors to carry out any of the described methods, in particular the methods of any of the fourteenth to twenty-second examples, or corresponding methods to any of the first to thirteenth examples.

According to a twenty-fourth example, there is provided a remote computing device comprising a processor, a memory, an input module, the input module operable to receive a signal from one or more sensors (e.g. as located within a security monitoring module, as described herein) located in a vicinity around a location of the computing device, and an output module, operably coupled to the input module, and operable to control one or more services running on the computer device in response to the signals received from the one or more sensors, wherein, in response to a signal received at the input module, the output module is configured to obfuscate (or terminate, log out of, etc) at least one of the one or more services running on the computer device. The aforementioned services under control may be an application, session, or operation of the whole device.

According to a twenty-fifth example there is provided a computer security system comprising: one or more sensors operably couplable to a remote computing device, wherein the one or more sensors are operable to detect a physical security breach of a location where the remote computing device is located; and wherein, in response to detection of the physical security breach by the one or more security sensors, the remote computing device is operable to obfuscate one or more activities running on the remote computing device.

It will also be appreciated that the tense of the wording used to describe the disclosed computer security system is not limiting, and therefore other tenses may be used, such that it is envisioned that the description, drawings and claims are not limited to items in actual use, but also to cover any and all items that are made available (configured, arranged, etc) to use in the disclosed way(s).

Embodiments of the present disclosure are useful for, by way of example only, home working environments for employees interacting with sensitive work-related data. For example, use of a magnetic contact sensor on a door to the working environment will enable any age-restricted sensitive content to be hidden if a child were to enter the room through the door whilst the parent or guardian is working via their work-provided laptop, tablet, or any other form of remote computing device, including multiple different devices being used at the same time.

All of the features disclosed in this specification (including any accompanying claims, abstract, and drawings) may be combined in any combination, except combinations where some features are mutually exclusive. Each feature disclosed in this specification, including any accompanying claims, abstract, and drawings, may be replaced by alternative features serving the same, equivalent, or similar purpose, unless expressly stated otherwise. Thus, unless expressly stated otherwise, each feature disclosed in one example may be used with any other example provided herein.

The present teachings are not restricted to the specific details of any of the foregoing examples. Any novel combination of the features disclosed in this specification (including any accompanying claims, abstract, and drawings) is envisaged. The claims should not be construed to cover merely the foregoing examples, but also any variants which fall within the scope of the claims.

1. A computer security system comprising:
one or more sensors operably couplable to a remote computing device, wherein the one or more sensors are operable to detect a physical security breach of a location where the remote computing device is located; and
wherein, in response to detection of the physical security breach by the one or more security sensors, the one or more sensors are operable to instigate the remote computing device to obfuscate one or more activities running on the remote computing device.

2. The computer security system of claim 1, wherein the one or more activities running on the remote computing device comprise any one or more of: execution of an operating system; execution of an application; and/or execution of session.

3. The computer security system of claim 1, wherein the remote computing device is operable to obfuscate the one or more activities by any one or more of: closing the one or more activities; rendering the one or more activities unviewable; and/or providing a visual warning to a user, said visual warning optionally overlaying a display of the one or more actives on the remote computing device.

4. The computer security system of claim 1, wherein the physical security breach of a location comprises any one or more of: an opening of a door in the location; an opening of a window in the location; or an opening of a covering in the location;
wherein the door or window or covering is operable to secure the location of the remote computing device from access by a third party person.

5. The computer security system of claim 1, wherein the one or more security sensors are any one or more of: a door sensor, operable to detect the opening of a door in the location; a window sensor, operable to detect the opening of a window in the location; a covering sensor, operable to detect the opening of a covering in the location; and/or a movement sensor, operable to detect a presence of a person in the location.

6. The computer security system of claim 5, wherein the door, window or covering sensor is a magnetic sensor or an optical sensor.

7. The computer security system of claim 1, wherein the one or more sensors are provided in one or more security monitoring modules, wherein said security monitoring modules are attachable to any door, window or covering in use around the location of the remote computing device.

8. The computer security system of claim 1, wherein the one or more sensors are operably coupled to the remote computing device using Bluetooth or Radio Frequency, RF, communications links.

9. The computer security system of claim 8, wherein the one or more security monitoring modules comprises a microcontroller operably coupled to an RF transceiver, wherein the microcontroller is operably arranged to detect the physical security breach and transmit a message, via the RF transceiver, to the one or more remote computing devices

10. The computer security system of claim 9, further comprising a plugin module to the remote computing device, wherein the plugin module further comprises a second microcontroller operably coupled to a second RF transceiver at the remote computing device side, wherein the second microcontroller is operably arranged to provide a signal to the remote computing device in response to the detection of the physical security breach by the one or more security sensors.

11. The computer security system of claim 9, wherein the first or second microcontroller is operably arranged to emulate a keyboard output for use by the remote computing device to action the obfuscation of the activities on the remote computing device.

12. The computer security system of claim 1, wherein, in response to detection of the physical security breach by the one or more security sensors, the system is operable to provide a signal indicating the occurrence of a physical security breach

13. The computer security system of claim 1, wherein the system is operable to provide a heartbeat signal indicative of any one or more of: the presence of a physical security breach; the presence of any one or more of the one or more security sensors; a power level state of any one or more of the one or more security sensors; system health metric(s).

14-15. (canceled)

16. A computer security method comprising:
providing one or more sensors operably couplable to a remote computing device, wherein the one or more sensors are operable to detect a physical security breach of a location where the remote computing device is located; and
in response to detection of the physical security breach by the one or more security sensors, the remote computing device obfuscating one or more activities running on the remote computing device.

17. The computer security method of claim 16, wherein the one or more activities running on the remote computing device comprise any one or more of: execution of an operating system; execution of an application; and/or execution of session.

18. The computer security method of claim 16, further comprising obfuscating the one or more activities by any one or more of: closing the one or more activities; rendering the one or more activities unviewable; and/or providing a visual warning to a user, wherein said visual warning optionally overlays a display of the one or more actives on the remote computing device.

19. The computer security method of claim 16, wherein the physical security breach of a location comprises any one or more of: an opening of a door in the location; an opening of a window in the location; or an opening of a covering in the location;
wherein the door or window or covering is operable to secure the location of the remote computing device from access by a third party person.

20. The computer security method of claim 16, wherein the one or more security sensors are any one or more of: a door sensor, operable to detect the opening of a door in the location; a window sensor, operable to detect the opening of a window in the location; a covering sensor, operable to detect the opening of a covering in the location; and/or a movement sensor, operable to detect a presence of a person in the location.

21. The computer security method of claim 16, wherein providing one or more sensors operably couplable to a remote computing device comprises providing one or more security monitoring modules comprising said one or more sensors, and wherein each security monitoring module comprises a microcontroller operably coupled to a Radio Frequency, RF, transceiver, wherein the microcontroller is operably arranged to detect the physical security breach and transmit a message, via the RF transceiver, to the one or more remote computing devices.

22-24. (canceled)

25. A remote computing device for use with the computer security system of claim 1, comprising:
a processor;
a memory;
an input module, the input module operable to receive a signal from one or more sensors located in a vicinity around a location of the computing device; and
an output module, operably coupled to the input module, and operable to control one or more services running on the computer device in response to the signals received from the one or more sensors;
wherein, in response to a signal received at the input module, the output module is configured to obfuscate at least one of the one or more services running on the computer device.
